(19) United States
(12) Patent Application Publication
(10) Pub. No.: US 2011/0209452 A1
(43) Pub. Date: Sep. 1, 2011

(54) Low Cost Cotton Harvester With Unit Speed Synchronized To Ground Speed

(76) Inventors: Kevin Jacob Goering, Cambridge, IA (US); Craig Alan Puetz, Waterloo, IA (US); Charles Ostermeier, Slater, IA (US); Daniel John Johannsen, Des Moines, IA (US)

(21) Appl. No.: 12/715,237

(22) Filed: Mar. 1, 2010

(51) Int. Cl. A01D 46/08; B05B 3/00

(52) U.S. Cl. 56/13.5; 56/14.7; 239/722

(57) ABSTRACT

A low cost cotton harvester (10) utilizing a tractor chassis (12) operated in the reverse direction includes a row unit is located forwardly of the drive wheels (20), and a single operator station (36) is situated above the drive wheels (20). A basket (60) is mounted above the engine (22) and the steerable wheels (18). The transmission (26) on the chassis (12) includes a mechanical front wheel drive (MFWD) output (30) located between the drive wheels (20) and the steerable rear wheels (18) which is connected to the row unit drive (50) to synchronize row unit drive speed with tractor drive wheel speed. The harvester fan (62) is connected to the existing power take off (PTO) shaft (32) on the tractor chassis (12) for operation independently of the row unit drive (50). Drop wheel axle structure (90) for the wheels may be used to provide crop clearance and to facilitate use of the chassis as a sprayer when the row unit (46) is removed. Sprayer pump structure (82) is driven by the PTO (32) when the chassis (12) is converted for spraying.

### FIELD OF THE INVENTION

The present invention relates generally to cotton harvesters and, more specifically, to a low cost cotton picker having row unit drive synchronized with vehicle ground speed.

### BACKGROUND OF THE INVENTION

A large percentage of cotton growing areas in the world rely on low-cost manual labor or custom harvesters to harvest crop. Most commercially available cotton harvesters are too expensive to effectively compete in these cotton growing areas.

A large portion of the cotton that is grown in the world today is still hand picked. Although there is a desire in many areas to mechanize picking, most current four row and six row pickers are too expensive for many of these markets. Lower cost two row harvesters are available, such as the John Deere 7260 Cotton Picker and the Pamak Ptm2 tractor mounted picking machine, but the transition away from hand picking and custom harvesting is still hindered by cost.

At the time cotton harvesting was being mechanized in North America and Australia, the two row self propelled picker was the premium product, and one row tractor mounted pickers were the low cost solution. While the one row tractor mounted picker worked and was relatively low in cost, productivity was also low. Other disadvantages were the time and effort required for mounting and dismounting, the complexity of design necessary to provide mounting structure to accommodate a wide variety of tractors, and the lack of synchronization of row unit speed directly to ground speed for efficient operation of the picker spindles as they engaged the cotton plants. As a result, production of the tractor mount pickers lasted only a short time. Two row self propelled pickers became predominant. Later, the two row self propelled machines were replaced by the presently available four, five and six row machines. The need exists for an improved lower cost, efficient harvester that overcomes the mounting and speed synchronizing problems encountered with many of the previous low cost designs.

### SUMMARY OF THE INVENTION

A low cost cotton harvester particularly desirable for emerging markets includes the incorporation of a tractor chassis with many components removed which are not necessary for operation of a cotton harvester. The tractor chassis is operated in the reverse direction, compared to the normal operation of a tractor, somewhat similar in fashion to the tractor mounted pickers that were prevalent around 1950 in North America. A row unit is located forwardly of the drive wheels, and an operator station is situated above the drive wheels to provide good visibility. A basket is mounted above the engine and the steerable wheels. Unlike the previous tractor mounted pickers, however, the chassis is substantially dedicated to cotton harvesting. In addition, the transmission on the chassis includes a mechanical front wheel drive (MFWD) output located between the drive wheels and the steerable rear wheels. In a conventional tractor chassis, the MFWD output would be drivingly connected to the steerable wheels. For the cotton harvester, the MFWD output is instead connected to the row unit drive. Since MFWD drive output is already synchronized with the tractor drive wheel speed, row unit drive is conveniently synchronized to ground speed using well established tractor drive technology and available components. When the tractor chassis stops, starts or changes speed, the row unit speed will change accordingly. By maintaining picking unit speed in synchronization with harvester ground speed, picking efficiency is increased and plant damage is decreased.

The harvester fan which provides air flow for propelling cotton between the row unit and the basket is driven by the existing power take off (PTO) shaft on the tractor chassis independently of the row unit drive. Therefore the fan can be run without need to drive the row units at the same time.

By providing a dedicated chassis, only a single set of controls is necessary so that duplication of operator station controls typically present in the afore-mentioned one row tractor mounted harvesters is avoided. The transmission gearing and tire size can be established to propel the machine at full speed in the harvester forward direction (the tractor reverse direction). Tire size may be specified to provide adequate ground clearance and to insure row unit synchronization to ground speed. The above-described configuration also advantageously places most of the harvester weight on the drive tires and aids mobility in adverse field conditions. The layout provides improved visibility and maneuverability to help the operator keep the harvester on the row. The leading row unit allows the operator to look forwardly and steer the unit directly on the row, and it assures less cotton is run over when a new field is opened.

Drop wheel axle structure for the drive wheels may be used to provide crop clearance and to facilitate use of the chassis as a sprayer when the row unit is removed. A sprayer pump is driven by the PTO shaft when the chassis is converted for spraying. A fully equipped tractor chassis rather than a stripped down tractor chassis may be used if the operator desires to convert the machine to normal tractor operation after the harvest season.

These and other objects, features and advantages of the present invention will become apparent from a reading of the description which follows when taken with the drawings.

### BRIEF DESCRIPTION OF THE DRAWINGS

FIG. 1 is a side view of a harvester including a row unit.

FIG. 2 is front view of the harvester of FIG. 1 with parts removed to show drive structure.

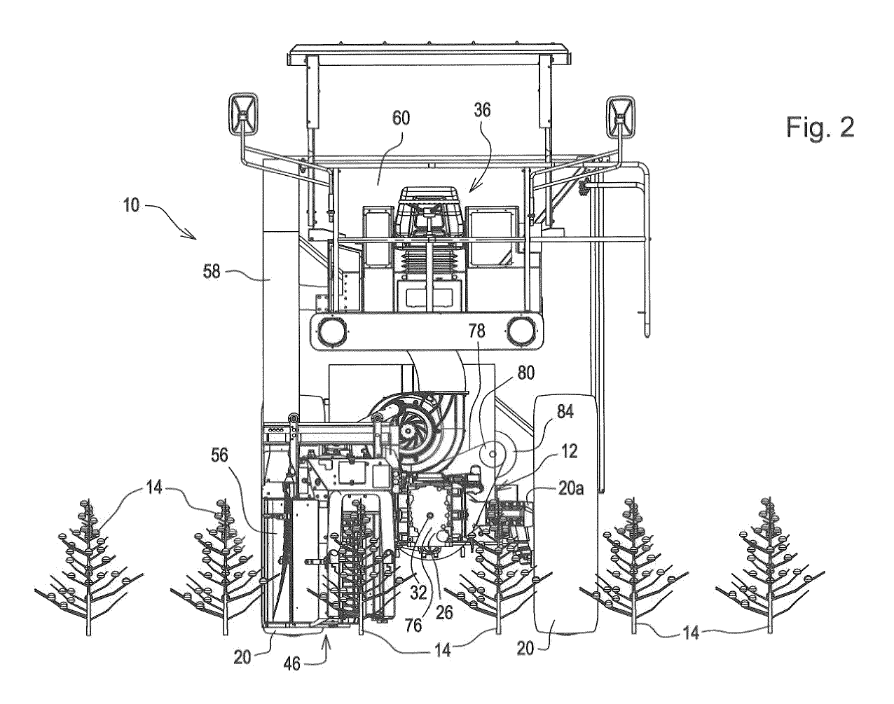

FIG. 3 is a side view of the harvester of FIG. 1 with parts removed to show the drive structure.

FIGS. 4 is a view of the harvester chassis looking back from the forward direction but with an offset drive to increase ground clearance and with the row unit removed and a spray boom connected.

### DESCRIPTION OF THE PREFERRED EMBODIMENT

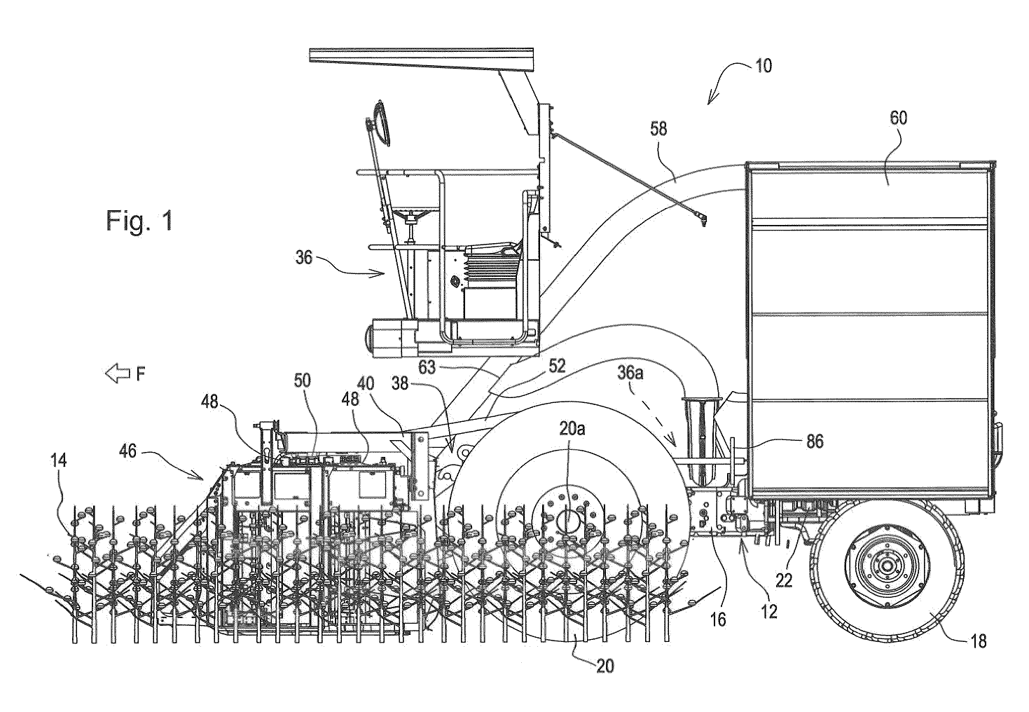

Referring now to FIG. 1, therein is shown a harvester 10 supported on a chassis 12 for movement in a forward direction F over a field of parallel rows of crop 14. As shown, the chassis 12 is a tractor chassis having a frame 16 supported by steerable wheels 18 and drive wheels 20 with axles 20a. An engine 22 supported on the frame 16 is connected to a standard drive transmission 26 and drives the wheels dependent on engine speed and selected gear ratio. In addition, a mechanical front wheel drive (MFWD) output 30 is provided between the wheels 18 and the drive wheel axles 20a. In a normal tractor operational mode, the MFWD output 30 would be connected to a mechanical drive for the steerable wheels 18. The speed of the MFWD output 30 is synchronized with the speed of the drive wheels 20 to provide steerable wheel drive assist in the normal tractor mode. A power take off (PTO) 32 provides a drive output independently of the drive wheel speed.

For the configuration shown, the chassis 12 is operated in a reverse mode with the drive wheels 20 in the leading position and the steerable wheels 18 trailing the drive wheels 20. The conventional tractor operator station above the axles 20a and between the drive wheels 20 is replaced with an elevated operator station 36 offset in the forward direction F from the axles 20a generally above hitch structure 38. Alternatively, if the chassis is to be converted for normal tractor operation part of the year, the conventional tractor operator station may still be provided at location 36a and the elevated station 36 may be removed.

A row unit mounting frame 40 is connected to the forward end hitch structure 38. The hitch structure 38 as shown is a conventional three-point tractor hitch and is movable vertically to raise and lower the frame 40. A harvester row unit 46 is connected to the mounting frame 40 and is movable vertically with the frame 40 between the field-working positions (shown) and a raised transport position with activation of the hitch structure 38. The row unit 46 is shown as a conventional cotton harvester row unit of the type shown and described in U.S. Pat. No. 5,519,988 issued May 28, 1996 and assigned to Deere & Company. The unit 46 includes spindle drums 48 rotated by a row unit drive 50 connected to a telescoping drive shaft 52 powered from the engine 22. The spindles of the drums 48 are rotated in contact with the cotton plants in a row of crop 14 to remove cotton form the plants, and doffer structure (not shown) doffs the cotton from the spindles and directs the cotton into row unit door structure 56 in a well-known manner. An air duct 58 conveys the removed crop from the door structure 56 to a basket 60 supported over the engine 22. Air from a fan 62 is blown upwardly through a nozzle 63 into the central portion of the duct 58 in a conventional manner to induce airflow up from the door structure 56 and then propel cotton upwardly and rearwardly into the basket 60.

To synchronize the row unit drive speed with the ground speed of the chassis 12, the drive shaft 52 is driven from the MFWD output 30. A pulley 64 on the output 30 is connected by a belt 66 connected to a second pulley 68 on the aft end of a connecting drive 70 supported above one of the axles 20a. The drive 70 extends forwardly over the axle 18a to a universal connection 74 which, in turn, is connected to the aft end of the drive shaft 52. Since the speed of the MFWD output 30 is tied directly to the speed of the chassis 12, any increase or decrease in speed will result in a corresponding increase or decrease in the drive speed of the rotating drums 48 to maintain synchronization of spindle velocity with the cotton plants passing through the row unit 46.

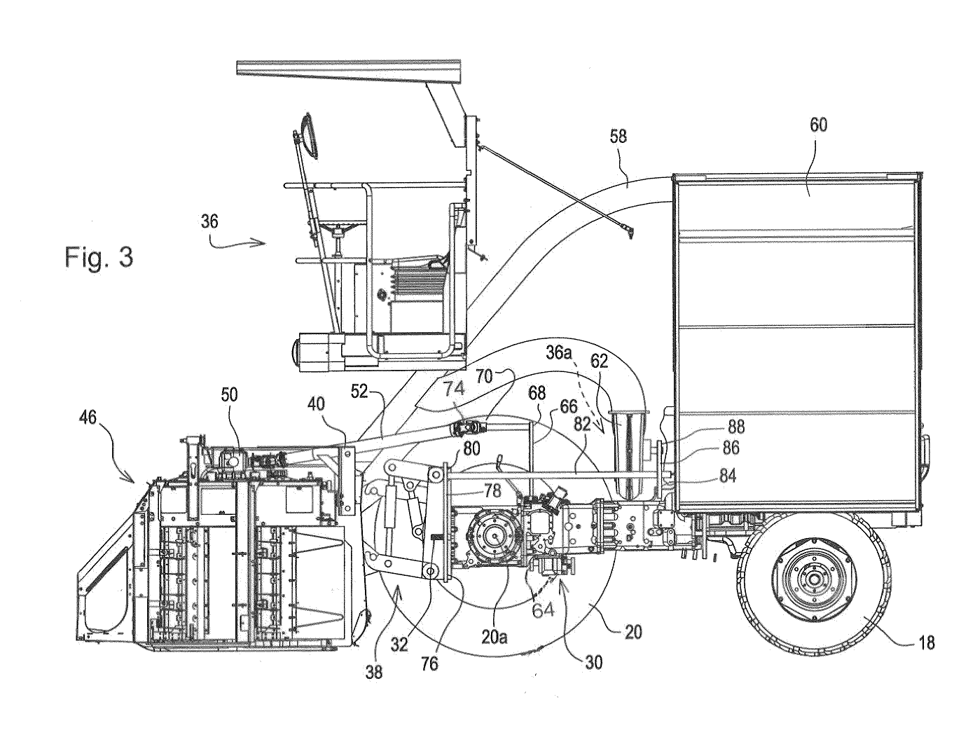

To provide drive of the fan 62 independently of operation of the row unit drive 50, the fan 62 may be powered from the PTO 32. As shown, a pulley 76 is connected to the PTO 32, and a belt 78 (FIG. 3) drives a second PTO drive pulley 80 supported at the forward end of an accessory drive shaft 82. The shaft 82 extends rearwardly over one of the drive wheel axles 20a to an aft end aligned with the fan 62. A pulley 84 mounted at the aft end of the shaft 82 drives a belt 86 and a fan pulley 88 to power the fan independently of the drive 50. Alternatively, other types of independent fan drives could be used, including but not limited to a hydraulic drive powered by the PTO 32. The fan 62 therefore can be operated even when the row unit drive 50 is shut down.

If desired, the chassis 12 may be converted to normal tractor operation by providing a conventional operator station at the location 36a and removing the row unit 46, basket 60 and any other hardware required for the harvester operation but not needed for tractor operation. A drive from the MFWD output 30 to drive assist structure on the steerable wheels 18 may also be reattached if necessary.

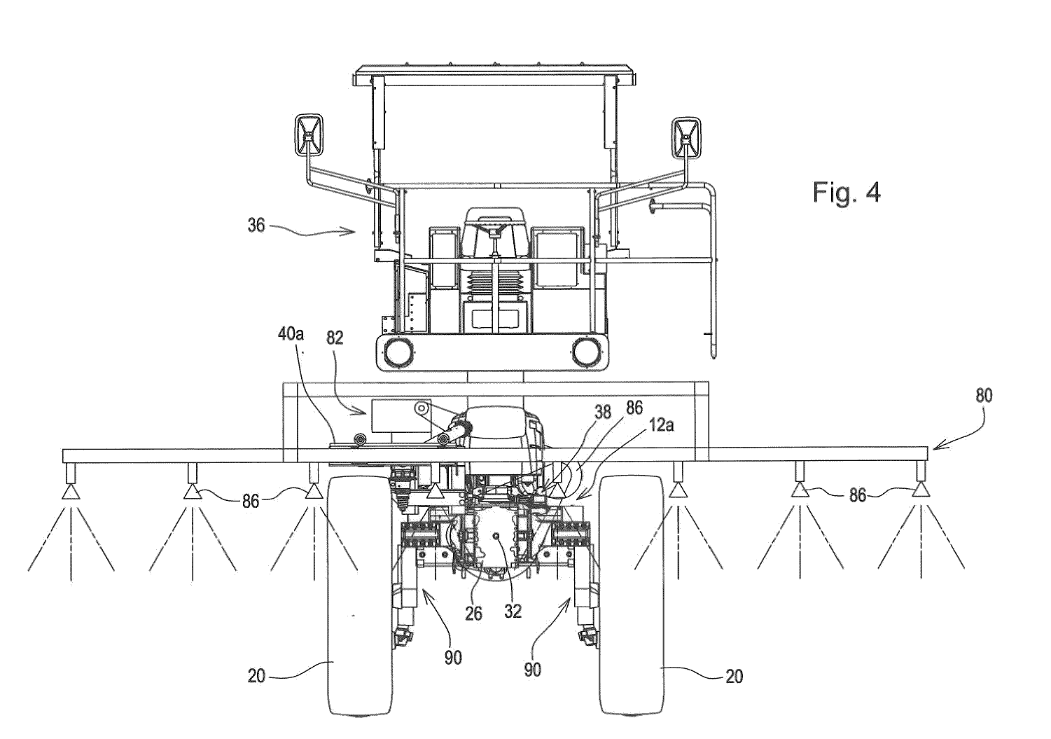

As shown in FIG. 4, the chassis 12 is modified for operation as a sprayer or similar other device. An attachment mounting frame 40a connected to the hitch structure 38 is shown supporting a spray boom 80. In the sprayer configuration of the chassis 12, the drive shaft 52 for the row unit may be removed or disconnected, and the fan 62 is replaced with pump structure 82 driven by the PTO 32, either through a belt drive arrangement similar to that shown for the harvester fan 62 or through a hydraulic drive, to supply spray fluid to spray nozzles 86 on the spray boom 80. For added elevation and crop clearance, drop wheel axle structure 90 can be added to raise the frame 16. The drop wheel axle structure 90 includes a mechanical internal drive powered from the axles 20a to drive the wheels 20. If desired, the drop wheel axle structure 90 may also be used for harvester operation to provide added clearance, particularly in tall cotton or the like. The drive wheels 20 are adjustable in and out to accommodate different row spacings and different combinations of rows to be straddled and harvested. In addition, in the harvester mode of operation, the row unit mounting frame 40 facilitates transverse adjustment of the row unit 46 relative to the frame 16 for added harvester compatibility with differing row patterns and spacings. For example, the row unit 46 may be mounted with rollers on the mounting frame 40 as shown and pinned at a selected on of various transversely spaced positions.

Having described the preferred embodiment, it will become apparent that various modifications can be made without departing from the scope of the invention as defined in the accompanying claims. For example, although a cotton harvester row unit driven by the MFWD output 30 is shown, other implements requiring ground speed synchronization could also be mounted on the chassis 12 and driven by the MFWD output 30 and other crop inputs could also be conveyed using an independent PTO drive.

1. An agricultural implement including a tractor chassis having a fore-and-aft extending frame with an engine, drive wheels having drive wheel axles supporting a first end of the frame and steerable wheels supporting a second end of the frame, drive transmission structure connected to the engine and to the drive wheels and having a mechanical front wheel drive (MFWD) output, wherein the speed of the MFWD output is synchronized with the speed of the drive wheels, a row unit extending from the first end of the frame, a crop receptacle supported by the frame, a crop conveyor supported on the frame, and a crop conveying duct extending from the row unit to the receptacle, the improvement comprising:
a row unit drive connected to the MFWD output, the MFWD output thereby driving the row unit at a speed dependent on the speed of the drive wheels.

2. The implement as set forth in claim 1 wherein the tractor chassis includes a power take off (PTO) shaft driven by the engine independently of the MFWD output, and a drive connecting the PTO shaft to the crop conveyor for operating the conveyor independently of the row harvesting unit.

3. The implement as set forth in claim 2 wherein the row unit comprises a spindle-type cotton picking unit movable through a row of cotton plants at a speed dependent on the speed of the drive wheels, wherein the picking unit includes a rotating spindle drum, the MFWD output rotating the spindle drum at a speed dependent on the speed of the steerable wheels to approximate a zero velocity of the spindles relative to the cotton plants, the MFWD output varying with changes in tractor chassis speed over the row of plants to thereby maintain a near zero velocity between the spindles and plants as the speed of the harvesting implement varies, and wherein the crop conveying fan comprises a cotton conveying fan.

4. The implement as set forth in claim 1 further comprising a mechanical drive connecting the drive transmission structure and the drive wheels.

5. The implement as set forth in claim 4 including upright leg structure supporting the drive wheel axles for rotation at locations offset substantially below an upper portion of the frame, the mechanical drive including transversely extending shaft structure connected to the drive transmission structure and a mechanical upright drive supported by the upright leg structure for driving the drive wheel axles below the transversely extending shaft.

6. The implement as set forth in claim 5 wherein the row unit is selectively attachable to and removable from the first end of the frame and MFWD output, and wherein the chassis comprises a sprayer chassis when the row harvesting unit is removed from the first end of the frame.

7. The implement as set forth in claim 6 including a sprayer pump supported by the frame, wherein the tractor chassis includes a power take off (PTO) shaft driven by the engine independently of the MFWD output, and drive structure powering the sprayer pump from the PTO shaft.

8. The implement as set forth in claim 6 including a spray boom assembly attachable to the first end of the frame when the row unit is removed from the first end of the frame.

9. An agricultural harvesting implement including a tractor chassis having a fore-and-aft extending frame with an engine, drive wheels having drive wheel axles supporting a first end of the frame and steerable wheels supporting a second end of the frame, drive transmission structure connected to the engine and to the drive wheels and having a mechanical front wheel drive (MFWD) output, a power take off (PTO) shaft driven by the engine independently of the MFWD output, wherein the speed of the MFWD output is synchronized with the speed of the drive wheels, a cotton row harvesting unit extending from the first end of the frame and including rotating spindles drums with spindles projecting into a row of cotton plants, a crop basket supported by the frame, a crop conveying fan supported by the frame, and a crop conveying duct extending from the row unit to the basket, the improvement comprising:
a row unit drive connected to the MFWD output, the MFWD output thereby driving the row unit at a speed dependent on the speed of the drive wheels to synchronize spindle drum rotation with harvester ground speed, and a drive powering the fan from the PTO shaft for operating the fan independently of the row harvesting unit.

10. The harvesting implement as set forth in claim 9 including upright leg structure supporting the drive wheel axles at locations offset below an upper portion of the frame, and a mechanical drive including transversely extending shaft structure connected to the drive transmission structure, and an upright drive supported by the upright leg structure connected at an upper end to the transversely extending shaft and at a lower end the drive wheel axles.

11. The harvesting implement as set forth in claim 10 wherein the row harvesting unit is selectively attachable to and removable from the first end of the frame and MFWD output, and wherein the chassis includes mounting frame structure for supporting a spray boom when the row harvesting unit is removed from the first end of the frame.

12. The harvesting implement as set forth in claim 11 including a sprayer pump supported on the frame, and pump drive structure powering the pump from the PTO shaft for operating the sprayer pump independently of the operation of the drive transmission structure.

13. The harvesting implement as set forth in claim 11 including a spray boom attachable to the mounting frame structure when the row harvesting unit is removed from the first end of the frame.

14. The harvesting implement as set forth in claim 11 wherein the row unit drive includes a fore-and-aft extending drive portion extending across one of the axles.

15. The harvesting implement as set forth in claim 11 including a fore-and-aft extending attachment drive connected to the PTO shaft and extending across one of the axles.
